(19) United States
(12) Patent Application Publication
(10) Pub. No.: US 2024/0381836 A1
(43) Pub. Date: Nov. 21, 2024

(54) MULTI-PURPOSE MODULAR PET TOWER

(71) Applicant: Joshua Bak, Houston, TX (US)

(72) Inventor: Joshua Bak, Houston, TX (US)

(21) Appl. No.: 18/197,123

(22) Filed: May 15, 2023

(51) Int. Cl. A01K 1/03; A01K 1/035

(52) U.S. Cl. CPC A01K 1/033; A01K 1/035; A01K 1/0356

(57) ABSTRACT

Disclosed herein is a multipurpose modular pet tower that includes a modular pet tower. The modular pet tower comprises sidewalls arranged vertically and spaced from each other, and connection plates arranged horizontally between the sidewalls to couple with the sidewalls. The multipurpose modular pet tower further includes an auxiliary attachment coupled to the modular pet tower. The auxiliary attachment extends vertically from at least one of the connection plates. The multipurpose modular pet tower further includes a locking attachment to couple the auxiliary attachment with the modular pet tower. A male locking member is coupled to the auxiliary attachment and a complementary female locking member is removably coupled to the at least one of the connection plates. The auxiliary attachment includes at least one of a cat feeding arrangement. The auxiliary attachment includes a cat playing arrangement.

### FIELD OF THE DISCLOSURE

The present disclosure relates generally to an indoor playing equipment, and, more specifically, relates to a multi-purpose modular pet tower, which is capable of optimizing space usage by adjusting the connecting status of modules in accordance with available space, and additionally capable of providing auxiliary attachments, such as a cat feeding arrangement to a cat playing arrangement, for cats to get involved as per the auxiliary attachments.

### BACKGROUND OF THE DISCLOSURE

Cats raised in human households are typically indoor cats whose activities are constrained by a small environment, which causes stress and a non-cartoon propensity. Such pet cats typically lack social skills due to stress from being in a small space and lack of exercise. In order to avoid this, it is vital to encourage the cats to exercise and to give them a private area to appropriately release stress. A common indoor plaything used for such activities are cat towers. Cat towers are appropriate plaything as per the habit of cats, which facilitate the cats in effortlessly moving up and down since cat towers are multi-layered construction that may be fitted in a small space.

Traditional cat towers are sold as finished goods, which has the drawback that they may not be modified to fit the needs of the pet pods to be fed according on their characteristics, size, or number. In addition, a restriction prevents the creation of a new play area for the pet due to the shape's impossibility to change.

Moreover, traditional cat towers also lack other additional engaging tools that may be incorporated with such cat towers to facilitate pet cats to play with such additional engaging tools to be engaged and be stress free.

There is a need for a multi-purpose modular cat tower that solves the problems associated with the traditional cat towers.

### SUMMARY OF THE DISCLOSURE

The objective of the current disclosure is to design a multi-purpose modular cat tower for building, disassembling, and reordering assemblies in accordance with user needs in a constrained environment. Such multi-purpose modular cat tower may also be additionally capable of providing auxiliary attachments, such as a cat feeding arrangement to a cat playing arrangement, for cats to get involved as per the auxiliary attachments.

In light of the above objects, in one aspect of the present disclosure, a multi-purpose modular pet tower is disclosed herein. The multi-purpose modular pet tower includes a modular pet tower. The modular pet tower includes sidewalls arranged vertically and spaced from each other. The modular pet tower further includes connection plates arranged horizontally between the sidewalls to couple with the sidewalls. The multi-purpose modular pet tower further includes an auxiliary attachment coupled to the modular pet tower. The auxiliary attachment extends vertically from at least one of the connection plates.

In one embodiment, the modular pet tower further includes a locking attachment to couple the auxiliary attachment with the modular pet tower. The locking attachment includes a male locking member. The male locking member is coupled to the auxiliary attachment. The locking attachment also includes a complementary female locking member. The complementary female locking member is removably coupled to the at least one of the connection plates. The male locking member and the complementary female locking member engage with each other to removably couple the auxiliary attachment with the modular pet tower.

In one embodiment, the auxiliary attachment further includes at least one of a cat feeding arrangement.

In one embodiment, the cat feeding arrangement includes a feeding plate member. The cat feeding arrangement further includes a support structure extending from a bottom of the feed plate member to be vertically couple with the at least one of the connection plates via the locking attachment.

In one embodiment, the auxiliary attachment includes a cat playing arrangement.

In one embodiment, the cat playing arrangement includes a support structure extending from a bottom of the feed plate member to be vertically couple with the at least one of the connection plates via the locking attachment.

In light of the above objects, in another aspect of the present disclosure, a multi-purpose modular pet tower is disclosed herein. The multi-purpose modular pet tower includes sidewalls. Each of the sidewalls having an inner surface, and an outer surface, and having opposite ends facing each other. The sidewalls further having a plurality of slots arranged on the inner surface of the sidewalls. The multi-purpose modular pet tower includes a plurality of attachment components. Each of the plurality of attachment components are parallelly arranged against each of the plurality of slots. The multi-purpose modular pet tower further includes a plurality of attachment components. Each of the plurality of attachment components are parallelly arranged against each of the plurality of slots. The multi-purpose modular pet tower further includes connection plates removably coupled with the plurality of attachment components. Each of the connection plates is inserted in each of the plurality of attachment components. The multi-purpose modular pet tower further includes a locking attachment removably coupled to the at least one of the connection plates. The locking attachment having a male locking member and a complementary female locking member. The complementary female locking member is removably coupled to the at least one of the connection plates. The multi-purpose modular pet tower further includes an auxiliary attachment adapted to be coupled to the male locking member to connect the auxiliary attachment to the complementary female locking member.

In one embodiment, the multi-purpose modular pet tower further includes an auxiliary locking element. The auxiliary attachment includes a first end portion and a second end portion. The auxiliary locking element is removably coupled to the second end portion of the auxiliary attachment. The male locking member is coupled to the first end portion to connect the auxiliary attachment to the complementary female locking member adapted to be coupled to an external member.

In one embodiment, the male locking member further includes a top surface and a bottom surface. The male locking member further includes recesses extending from the top surface to the bottom surface to receive screws to couple the male locking member to another complementary female locking member. The male locking member further includes a pair of spaced-prongs extending from the bottom surface to form a channel portion there between to engage with the first end portion of the auxiliary attachment. The male locking member further includes an engaging element arranged on the top surface and a pair of engaging slots arranged along sides of the engaging element extending from the top surface to the bottom surfaces. The male locking member further includes a supporting extension arranged between two adjacent recesses of the recesses.

In one embodiment, the complementary female locking member includes through holes to receive screws to couple the complementary female locking member with the at least one of the connection plates. The complementary female locking member further includes a complimentary engaging cavity to engage with the engaging element of the male locking member, when the male locking member is engaged with the complementary female locking member. The complementary female locking member further includes a pair of complementary engaging ridges to engage with the pair of engaging slots of the male locking member, when the male locking member is engaged with the complementary female locking member. The complementary female locking member further includes supporting complementary slots arranged between the pair of complementary engaging ridges to accommodate the supporting extension of the male locking member, when the male locking member is engaged with the complementary female locking member.

In one embodiment, each of the sidewalls includes a plurality of through holes arranged along a corner portion thereof. Each of the sidewalls includes connectors adapted to be inserted into the plurality of through holes associated with each of the adjacent sidewalls to couple adjacent sidewalls with respect to each other.

In one embodiment, one or more side wall of the side walls having one of a polygonal shape, a circular shape, a square shape, a rectangular shape, a hexagonal shape, an elliptical shape, any definite shape, or combination thereof, and includes at least one of a through opening to allow pets to enter and exit, a plurality of definite shape apertures, a paw structure.

In one embodiment, at least one of the connection plates includes a cushion connecting plate on which a cushion is arranged.

In one embodiment, each of the connection plates includes a first end portion and a second end portion. The first end portion includes a plurality of spring locks corresponding to the plurality of attachment components, and are arranged on both sides of each of the connection plates such that each of the connection plates is coupled with the each of the plurality of attachment components.

In one embodiment, each spring lock of the plurality of spring locks of the connection plates includes a base, a plurality of branches projecting from the base and arranged in a row in spaced relation. Further, each spring lock of the plurality of spring locks of the connection plates includes a plurality of elastic space arranged in alternating relation with respect to the plurality of branches to be elastically coupled to the plurality of attachment components.

In one embodiment, each attachment component of the plurality of attachment components includes a separator for expanding the at least one elastic space of the plurality of elastic space. Each attachment component of the plurality of attachment components further includes an insertion hole of a shape corresponding to the plurality of branches.

In one embodiment, the auxiliary attachment includes at least one of a cat feeding arrangement.

In one embodiment, the cat feeding arrangement includes a feeding plate member and a support structure extending from a bottom of the feed plate member to be vertically couple with the at least one of the connection plates via the locking attachment.

In one embodiment, the auxiliary attachment includes a cat playing arrangement.

In one embodiment, the cat playing arrangement includes a support structure extending from a bottom of the feed plate member to be vertically couple with the at least one of the connection plates via the locking attachment.

These elements, together with the other aspects of the present disclosure and various features are pointed out with particularity in the claims annexed hereto and form a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawing, in which:

FIG. 1 illustrates an assembled view of the multi-purpose modular pet tower with an auxiliary attachment, such as a cat feeding arrangement, in accordance with an exemplary embodiment of the present disclosure;

FIG. 2 illustrates an assembled view of the multi-purpose modular pet tower with an auxiliary attachment, such as a cat playing arrangement, in accordance with an exemplary embodiment of the present disclosure:

FIG. 3 illustrates an exploded view of the multi-purpose modular pet tower of FIG. 1, in accordance with an exemplary embodiment of the present disclosure:

FIG. 4 illustrates an exploded view of a sidewall with an attachment component of the multi-purpose modular pet tower, in accordance with an exemplary embodiment of the present disclosure:

FIGS. 5A-5D illustrate various views of attachment components of the multi-purpose modular pet tower, in accordance with an exemplary embodiment of the present disclosure:

FIGS. 6A-6B, respectively, illustrate perspective views of a female locking member and a male locking member of a locking attachment of the multi-purpose modular pet tower, in accordance with an exemplary embodiment of the present disclosure:

FIG. 7 illustrates a perspective view of a cat feeding arrangement, in accordance with an exemplary embodiment of the present disclosure:

FIG. 8 illustrates an unassembled view of the cat feeding arrangement, in accordance with an exemplary embodiment of the present disclosure:

FIG. 9 illustrates a perspective view of a cat playing arrangement, in accordance with an exemplary embodiment of the present disclosure: and

FIG. 10 illustrates a perspective view of another cat playing arrangement, in accordance with an exemplary embodiment of the present disclosure.

Like reference, numerals refer to like parts throughout the description of several views of the drawing.

### DETAILED DESCRIPTION OF THE DISCLOSURE

The following is a detailed description of embodiments of the disclosure depicted in the accompanying drawings. The embodiments are in such detail as to communicate the disclosure. However, the amount of detail offered is not intended to limit the anticipated variations of embodiments: on the contrary, the intention is to cover all modifications, equivalents, and alternatives falling within the spirit and scope of the present disclosure.

In the following description, numerous specific details are set forth in order to provide a thorough understanding of the embodiments of the present disclosure. It may be apparent to one skilled in the art that embodiments of the present disclosure may be practiced without some of these specific details.

Various terms as used herein are shown below. To the extent a term is used, it should be given the broadest definition persons in the pertinent art have given that term as reflected in printed publications and issued patents at the time of filing.

The terms “a” and “an” herein do not denote a limitation of quantity, but rather denote the presence of at least one of the referenced items.

The terms “having”, “comprising”, “including”, and variations thereof signify the presence of a component.

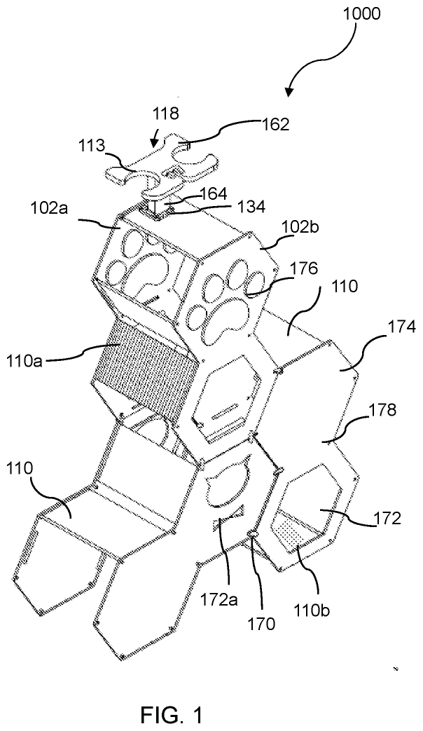

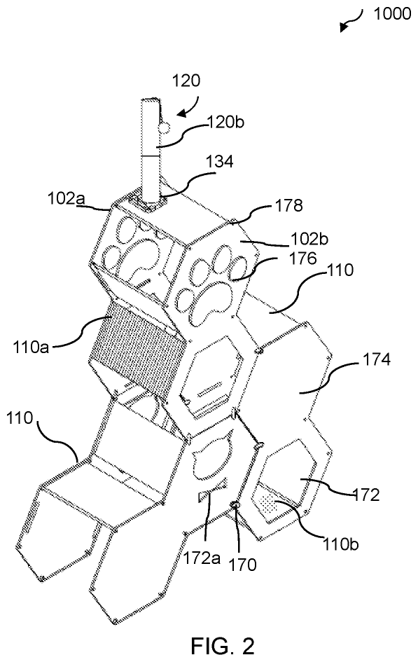

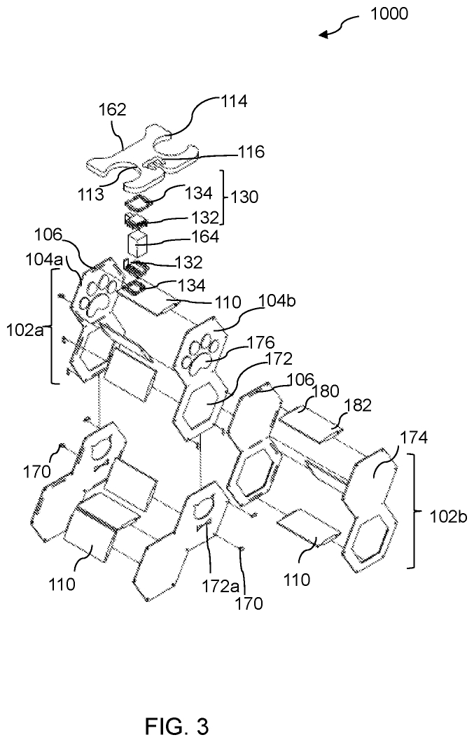

Referring now to FIG. 1 to FIG. 10 to describe various exemplary embodiments of the present disclosure. FIG. 1 illustrates an assembled view of the multi-purpose modular pet tower 100 with a cat feeding arrangement 118 (herein after may also be referred to as ‘pet tower 1000’), in accordance with an exemplary embodiment of the present disclosure. The multi-purpose modular pet tower 1000 includes a modular pet tower 100, at least one auxiliary attachment 118, 120, and a locking attachment 130. The modular pet tower 100 includes sidewalls 102a, 102b having a plurality of slots 106, a plurality of attachment components 108 to engage with the plurality of slots, and connection plates 110 to be coupled with the sidewalls via the plurality of attachment components 108. Further, the at least one auxiliary attachment 118, 120, may be coupled to the modular pet tower 100 via the locking attachment 130.

The sidewalls 102a, 102b of the modular pet tower 100 are arranged vertically and spaced from each other. Each of the sidewalls 102a, 102b includes a plurality of through holes 178 arranged along a corner portion thereof. Further, each of the sidewalls 102a, 102b includes connectors 170 adapted to be inserted into the plurality of through holes 178 associated with each of the adjacent sidewalls 102a, 102b to couple adjacent sidewalls 102a, 102b with respect to each other. One or more side wall of the side walls 102a, 102b may be of various shapes and designs, for example, including, but not limited to, a polygonal shape, a circular shape, a square shape, a rectangular shape, a hexagonal shape, an elliptical shape, any definite shape, and so forth. In one example, at least one of the side walls may include at least one of a through opening 172, a plurality of definite shape apertures 172a, a solid wall without cut-out 174, and a paw structure 176.

The through opening 172 may allow the pets, such as cat, to enter and exit therefrom. Further, the plurality of definite shape apertures 172a might serve as a supporting framework so that the pet may easily ascend the modular pet tower 100. In one variation, the plurality of definite shape apertures 172a might also serve as a play area for pets. Furthermore, the paw structure 176 may be a printed framework in one embodiment. Another variation of the paw structure 176 may be a cut-out in the shape of a paw that the pet may use to climb the modular pet tower 100 with ease.

Referring to FIG. 1 to FIG. 3, the connection plates 110 of the pet tower 1000 may be arranged horizontally between the sidewalls 102a, 102b to couple with the sidewalls 102a, 102b. In one example, each of the connection plates 110 acts as a support for a pet to walk when each connection plate 110 is positioned between the sidewalls 102a, 102b. In one embodiment, at least one of the connection plates 110 may be a cushion connecting plate on which a cushion is arranged, for example, as seen in FIG. 1 with reference numeral 110b. In one another embodiment, one of the connection plates 110 may include a scratch connecting plate 110a with a surface made of a rough material. The connection plates 110 may be removably coupled with the plurality of attachment components 108.

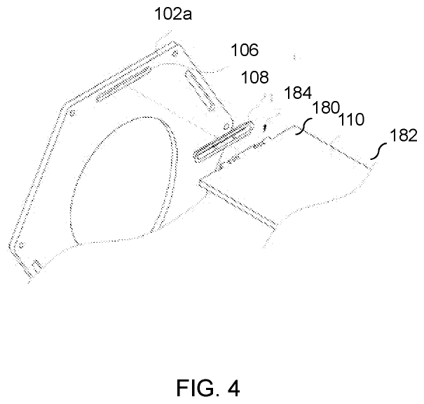

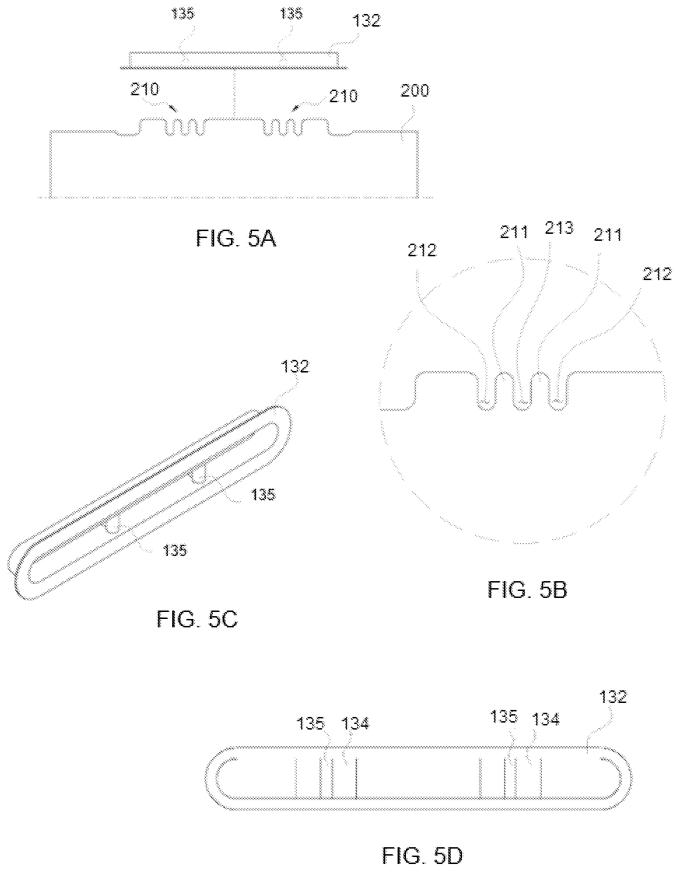

As mentioned herein above, as shown in FIGS. 5A to 5D, each of the plurality of attachment components 108 may be parallelly arranged against each of the plurality of slots 106, as seen in enlarged vie of FIG. 4, to be engage with the plurality of slots 106. Each attachment component 108 includes a separator 135 for expanding the at least one elastic space of the plurality of elastic space 212. Each attachment component of the plurality of attachment components 108 further includes an insertion hole 134 of a shape corresponding to the plurality of branches 211.

Each of the connection plates 110 may be inserted in each attachment component 108 of the plurality of attachment components 108. Each of the connection plates 110 includes a first end portion 180 and a second end portion 182. The first end portion 180 includes a plurality of spring locks 184 corresponding to the plurality of attachment components 108, and are arranged on both sides of each of the connection plates 110 such that each of the connection plates 110 is coupled with the each of the plurality of attachment components 108, as seen in FIG. 4.

Further, the connection plates 110 includes a plurality of spring locks 184. each spring lock of the plurality of spring locks 184 of the connection plates 110 includes a base, a plurality of branches 211 projecting from the base and arranged in a row in spaced relation. Further, each spring lock of the plurality of spring locks 184 of the connection plates 110 includes a plurality of elastic space 212 arranged in alternating relation with respect to the plurality of branches 211 to be elastically coupled to the plurality of attachment components 108.

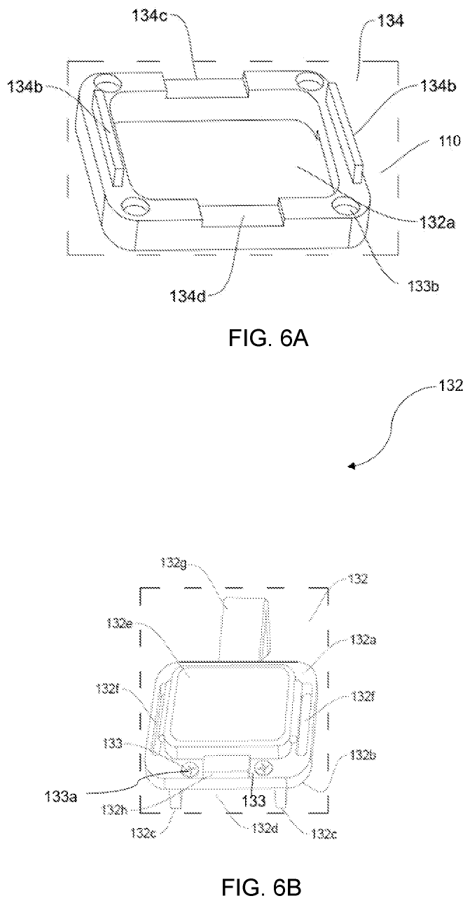

Referring now to FIGS. 6A and 6B, the locking attachment 130 may include a male locking member 132, as seen in FIG. 6B, and a complementary female locking member, as seen in FIG. 6A to be received in the male locking member 132. The male locking member 132 may be coupled to the auxiliary attachment 118, 120 to attach the auxiliary attachment 118, 120 with the modular pet tower 100. In one example configuration, the male locking member 132 further includes a top surface 132a, and a bottom surface 132b. The male locking member 132 further includes recesses 133 extending from the top surface 132a to the bottom surface 132b to receive screws 133a to couple a first end portion 122 of the auxiliary attachment 118, 120. The male locking member 132 further includes a pair of spaced-prongs 132c extending from the bottom surface 132b to form a channel portion 132d therebetween to engage with a second end portion 124 of the auxiliary attachment 118, 120. The male locking member 132 further includes an engaging element 132e arranged on the top surface 132a, and a pair of engaging slots 132f arranged along sides of the engaging element 132e extending from the top surface 132a to the bottom surfaces 132b. The male locking member 132 further includes a supporting extension 132h arranged between two adjacent recesses of the recesses 133.

Further, the complementary female locking member 134, as seen in FIG. 6A may be removably coupled to the at least one of the connection plates 110. The complementary female locking member 134 may include through holes 133b to receive screws to couple the complementary female locking member 134 with the at least one of the connection plates 110. The complementary female locking member 134 further includes a complimentary engaging cavity 132a to engage with the engaging element 132e of the of the male locking member 132, when the male locking member 132 is engaged with the complementary female locking member 134. The complementary female locking member 134 further includes a pair of complementary engaging ridges 134b to engage with the pair of engaging slots 132f of the male locking member 132, when the male locking member 132 is engaged with the complementary female locking member 134. The complementary female locking member 134 further includes supporting complementary slots 134c, 134d arranged between the pair of complementary engaging ridges 134b to accommodate the supporting extension 132h of the male locking member 132, when the male locking member 132 is engaged with the complementary female locking member 134.

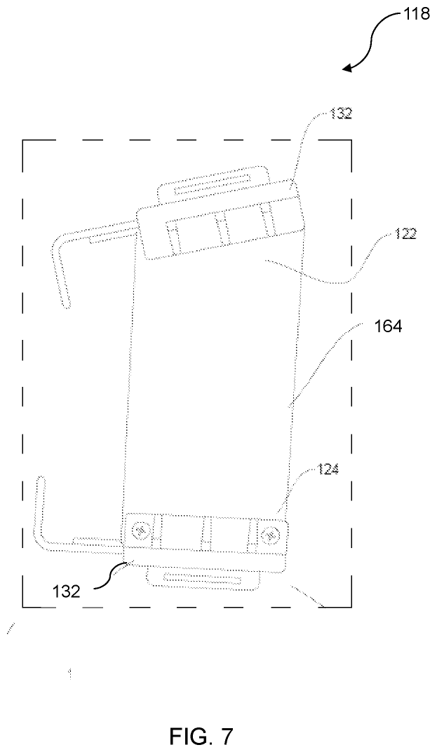

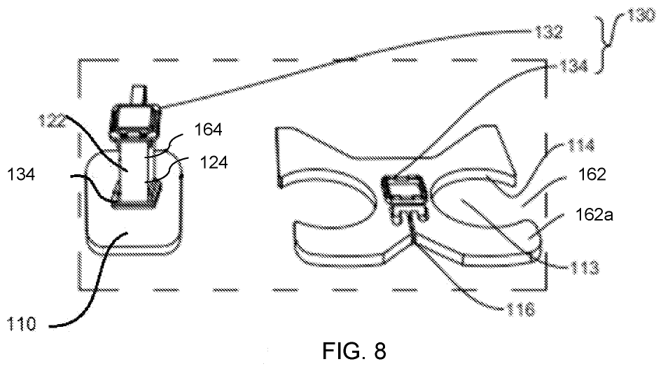

As mentioned above, and seen in FIGS. 7-9, the pet tower 1000 includes the auxiliary attachment coupled to the modular pet tower 100 via the locking attachment 130, as described above. According to one embodiment, the auxiliary attachment 118, 120 may be a cat feeding arrangement 118, and now will be described in conjunction to FIGS. 7 and 8A-8B. As seen, the cat feeding arrangement 118 includes a feeding plate member 162 and a support structure 164. The support structure 164 has first and second end portions, and is also referred to the first and second end portions 122, 124 of the auxiliary components 118. The auxiliary attachment 118, 120, from its second end portion 124 extends vertically from at least one of the connection plates 110, as seen in FIG. 1 to FIG. 3. Further, the first end portion 122 of the support structure 164 may extend from a bottom 162a of the feeding plate member 162 to be vertically couple with the at least one of the connection plates 110 via the locking attachment 130, as seen in FIG. 8. The first end portion 122 of the support structure 164 may be coupled via an auxiliary locking element, which is similar to the locking attachment 130, and also includes a male locking member, similar to the male locking member 132, a complementary female locking member, similar to the complementary female locking member 134, and is avoided from further explanation for the sake to brevity.

In an example, the feeding plate member 162 may be shaped like a circular plate, a rectangular plate, a square plate, an oval plate, or any other specific shape. In one example, the feeding plate member 162 may have cut-outs 113 with a rim 114 to receive utensils to serve various dishes to the pet. The cut-outs 113 complements a shape of the utensils, which may include a substantially semi-circular shape and the cut-outs 113, may removably receive the utensils of a pre-determined diameter into an interior space of the cut-outs 113. Additionally, the feeding plate member 162 could be split into two pieces, with a cantilever arrangement 116 placed in the middle of the feeding plate member 162.

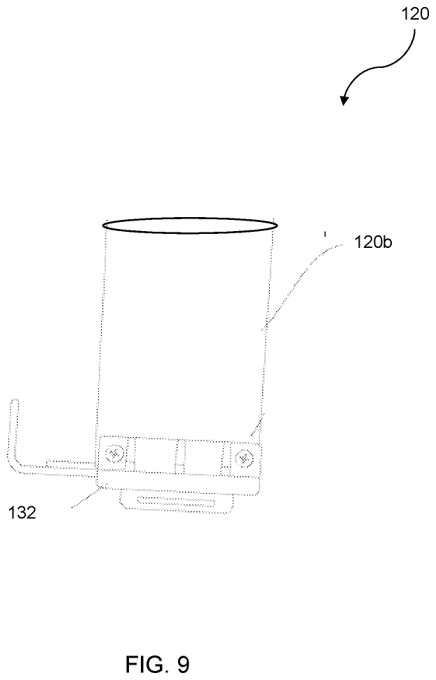

According to another embodiment, the at least one auxiliary attachment may be a cat playing arrangement 120, as seen in FIG. 9. The cat playing arrangement 120 includes a support structure 120b to be vertically couple with the at least one of the connection plates 110 via the male locking member 132, as seen in FIG. 6B, and the complementary female locking member 134, as seen in FIG. 6A of the locking attachment 130. Further explanation is excluded herein for the sake of brevity.

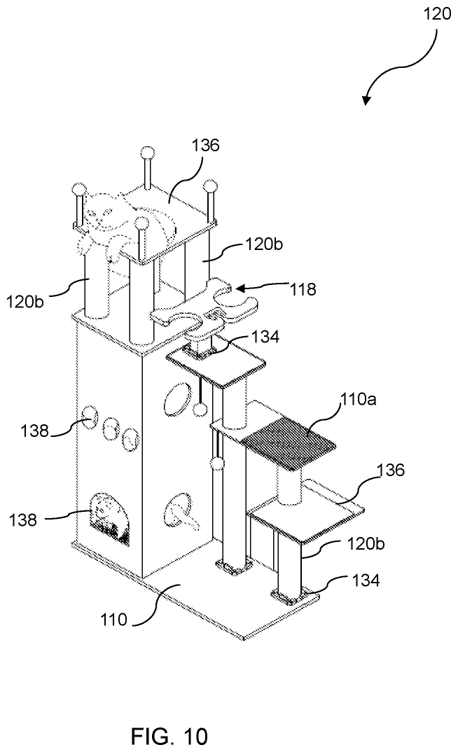

With reference to FIG. 10, a multipurpose modular pet tower illustrating a modular pet tower 100 of varying design and an auxiliary attachment, such as a cat playing arrangement 120, according to another example. The cat playing arrangement 120 may include various structural elements to arrange such structure. As shown the arrangement may have various support structures 120b that are vertically coupled to at least one of the connection plates 110 by the male locking member 132 and the complementary female locking member 134 of the locking attachment 130, which are shown in FIGS. 6A and 6B, respectively. Additionally, the cat feeding arrangement 118 on top of one of the connecting plates 110 may be present. Additionally, one of the connection plates 110 could be detachably attached to the scratch connecting plate 110a and have a surface formed of a rough material. Every one of the various support structures 120 may be connected to a structure 136 that resembles a flat plate and which cats may use as a step when climbing, strolling, playing, or even sitting. Additionally, the cat playing arrangement 120 may have holes 138 of various sizes and shapes for the cat to peek through, explore, or sit in. Further explanation is excluded herein for the sake of brevity. The modular pet towers as shown in various figures are only for example and understanding purpose, however, without departing from the scope of the present disclosure any other design of the modular pet tower is also considered to be part of present disclosure.

The multi-purpose modular pet tower 1000 encourages activity in pets and offers a private area where stress may be appropriately released. The multi-purpose modular pet tower 1000 is a multi-layered structure that is established in a small space as indoor play equipment and is appropriate for a pet's natural tendency to move up and down without difficulty. The design module of the multi-purpose modular cat tower 1000 enables pet owners for building, disassembling, and reordering assemblies in accordance with user needs in a constrained environment. Further, multi-purpose modular cat tower also additionally includes auxiliary attachments 118, 120, such as a cat feeding arrangement 118 to cat playing arrangement 120, for cat to get involved as per the auxiliary attachments.

The foregoing descriptions of specific embodiments of the present disclosure have been presented for purposes of illustration and description. They are not intended to be exhaustive or to limit the present disclosure to the precise forms disclosed, and many modifications and variations are possible in light of the above teaching. The embodiments were chosen and described to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the present disclosure.

What is claimed is:

1. A multipurpose modular pet tower comprising:
a modular pet tower, wherein the modular pet tower comprises sidewalls arranged vertically and spaced from each other, and connection plates arranged horizontally between the sidewalls to couple with the sidewalls; and
an auxiliary attachment coupled to the modular pet tower, wherein the auxiliary attachment extends vertically from at least one of the connection plates.

2. The multipurpose modular pet tower of claim 1, further comprising:
a locking attachment to couple the auxiliary attachment with the modular pet tower, wherein the locking attachment comprises:
a male locking member, wherein the male locking member is coupled to the auxiliary attachment; and
a complementary female locking member, wherein the complementary female locking member is removably coupled to the at least one of the connection plates;
wherein the male locking member and the complementary female locking member engage with each other to removably couple the auxiliary attachment with the modular pet tower.

3. The multipurpose modular pet tower of claim 1, wherein the auxiliary attachment comprises at least one of a cat feeding arrangement.

4. The multipurpose modular pet tower of claim 3, wherein the cat feeding arrangement comprises:
a feeding plate member; and
a support structure extending from a bottom of the feed plate member to be vertically couple with the at least one of the connection plates via a locking attachment.

5. The multipurpose modular pet tower of claim 1, wherein the auxiliary attachment comprises a cat playing arrangement.

6. The multipurpose modular pet tower of claim 5, wherein the cat playing arrangement comprises:
a support structure extending vertically and coupled to the at least one of the connection plates via the locking attachment.

7. A multipurpose modular pet tower comprising:
sidewalls, each of the sidewalls having an inner surface, and an outer surface, and having opposite ends facing each other, the sidewalls further having:
a plurality of slots arranged on the inner surface of the sidewalls;
a plurality of attachment components, each of the plurality of attachment components are parallelly arranged against each of the plurality of slots;
connection plates removably coupled with the plurality of attachment components, each of the connection plates is inserted in each of the plurality of attachment components;
a locking attachment removably coupled to the at least one of the connection plates, the locking attachment having a male locking member and a complementary female locking member, wherein the complementary female locking member is removably coupled to the at least one of the connection plates; and
an auxiliary attachment adapted to be coupled to the male locking member to connect the auxiliary attachment to the complementary female locking member.

8. The multipurpose modular pet tower of claim 7, further comprising:
an auxiliary locking element and wherein the auxiliary attachment includes a first end portion and a second end portion;
wherein the auxiliary locking element is removably coupled to the second end portion of the auxiliary attachment, and wherein the male locking member is coupled to the first end portion to connect the auxiliary attachment to the complementary female locking member adapted to be coupled to an external member.

9. The multipurpose modular pet tower of claim 7, wherein the male locking member further comprises:
a top surface and a bottom surface,
recesses extending from the top surface to the bottom surface to receive screws to couple the male locking member to another complementary female locking member;
a pair of spaced-prongs extending from the bottom surface to form a channel portion there between to engage with the first end portion of the auxiliary attachment;
an engaging element arranged on the top surface,
a pair of engaging slots arranged along sides of the engaging element extending from the top surface to the bottom surfaces, and
a supporting extension arranged between two adjacent recesses of the recesses.

10. The multipurpose modular pet tower of claim 9, wherein the complementary female locking member comprises:
through holes to receive screws to couple the complementary female locking member with the at least one of the connection plates;
a complimentary engaging cavity to engage with the engaging element of the of the male locking member, when the male locking member is engaged with the complementary female locking member;
a pair of complementary engaging ridges to engage with the pair of engaging slots of the male locking member, when the male locking member is engaged with the complementary female locking member;
supporting complementary slots arranged between the pair of complementary engaging ridges to accommodate the supporting extension of the male locking member, when the male locking member is engaged with the complementary female locking member.

11. The multipurpose modular pet tower of claim 7, wherein each of the sidewalls comprises:
a plurality of through holes arranged along a corner portion thereof; and
connectors adapted to be inserted into the plurality of through holes associated with each of the adjacent sidewalls to couple adjacent sidewalls with respect to each other.

12. The multipurpose modular pet tower of claim 7, wherein one or more side wall of the side walls having one of a polygonal shape, a circular shape, a square shape, a rectangular shape, a hexagonal shape, an elliptical shape, any definite shape, or combination thereof, and comprises at least one of:
a through opening to allow pets to enter and exit;
a plurality of definite shape apertures;
a paw structure.

13. The multipurpose modular pet tower of claim 1, wherein at least one of the connection plates comprises a cushion connecting plate on which a cushion is arranged.

14. The modular pet tower of claim 1, wherein each of the connection plates comprises:
a first end portion,
a second end portion,
wherein the first end portion comprises a plurality of spring locks corresponding to the plurality of attachment components, and are arranged on both sides of each of the connection plates such that each of the connection plates is coupled with the each of the plurality of attachment components.

15. The multipurpose modular pet tower of claim 14, wherein each spring lock of the plurality of spring locks of the connection plates comprises:
a base;
a plurality of branches projecting from the base and arranged in a row in spaced relation;
a plurality of elastic space arranged in alternating relation with respect to the plurality of branches to be elastically coupled to the plurality of attachment components.

16. The multipurpose modular pet tower of claim 15, wherein each attachment component of the plurality of attachment components further comprises:
a separator for expanding the at least one elastic space of the plurality of elastic space; and
an insertion hole of a shape corresponding to the plurality of branches.

17. The multipurpose modular pet tower of claim 7, wherein the auxiliary attachment comprises at least one of a cat feeding arrangement.

18. The multipurpose modular pet tower of claim 17, wherein the cat feeding arrangement comprises:
a feeding plate member; and
a support structure extending from a bottom of the feed plate member to be vertically couple with the at least one of the connection plates via the locking attachment.

19. The multipurpose modular pet tower of claim 7, wherein the auxiliary attachment comprises and a cat playing arrangement.

20. The multipurpose modular pet tower of claim 19, wherein the cat playing arrangement comprises:
a support structure extending from a bottom of the feed plate member to be vertically couple with the at least one of the connection plates via the locking attachment.
